(19) United States
(12) Patent Application Publication
(10) Pub. No.: US 2002/0081122 A1
(43) Pub. Date: Jun. 27, 2002

(54) Image forming apparatus and image forming method which performing doubly sort printing

(75) Inventor: Masahiro Ohwa, Tokyo (JP)

Correspondence Address: Foley & Lardner, Suite 500, 3000 K Street, N.W., Washington, DC, 20007-5109, US

(73) Assignee: TOSHIBA TEC KABUSHIKI KAISHA

(21) Appl. No.: 09/742,429

(22) Filed: Dec. 22, 2000

(51) Int. Cl. G03G 15/00

(52) U.S. Cl. 399/82

(57) ABSTRACT

An image forming apparatus has a forming mechanism (6) forming, upon receipt of a sort printing instruction, an image on a plurality of recording media based on given image information, a sensor (29) for detecting an empty state of each bin in a sorter, a control circuit (12) for judging whether or not to feed the plurality of recording media as an additional print output into bins based on a result of this detection, and an output mechanism (21) for, if it is judged that this can be done, allows the recording media to be fed as an additional print output into the corresponding bins in the sorter, in which whether or not the recording media can be additionally print-outputted is automatically judged, for example, under the condition that the former user and current user is the same person and printing can be carried out in a sort mode.

### BACKGROUND OF THE INVENTION

The present invention relates to an image forming apparatus for performing sort printing with the use of sorting bins and, in particular, to performing additional sort printing.

Recently, the image forming apparatus has the function of not only reproducing an image on a given document onto copying sheets but also forming an image in accordance with a copying mode matched to a desired specification of various users and has been so used as required. In a sort printing mode of those modes used, for example, a 8-page document is copied on sheets, respectively, corresponding to 12 persons and the copied sheets are fed as a printed output into sorter bins. By doing so, the original document is copied in number corresponding to only the persons involved and there is no such inconvenience that, as in the case of not using a sort printing mode, the user has to copy document pages one by one and sort them in number corresponding to the persons involved. For this reason, the image forming apparatus having a sort printing mode has a sorting mechanism such that sorter bins are stacked in numbers corresponding to a plurality of sheets. Sort printing processing is done on the sheets set and the printed sheets, being sorted, are fed into corresponding sorter bins. By doing so, the user can obtain those printed sheets, in sorted form, in number corresponding to several persons involved and this obviates the need to perform any cumbersome sorting operation.

However, the sorter bins are mechanical and their handling numbers are restricted and, if any excessive number is set, it is not possible to perform printing in sort form. On the other hand, the recent image forming apparatus has been systematized to include, for example, a network function and it is connected by a LAN (Local Area Network) cable, etc., or via the LAN, to a network. The apparatus has been increasingly used to receive a sort printing instruction from a PC (Personal Computer) on the network and hence to receive a plurality of instructions to perform sort printing.

When, in such a case, the sort printing has been done and corresponding printed sheets have already been fed into the sorter bins, if a sort printing job is again sent to the apparatus, then a warning is issued to the user, indicating that there are the sheets in the sorter, and this sort printing is not done. Thus, if the sort printing job is sent in a state that there are already printed sheets, then a warning is issued to the user, indicating that there are the sheets, and printing is interrupted. It is, therefore, necessary for the user to once go to the image forming apparatus and remove the sheets from the sorter. If such sort printing job is continuously sent to the apparatus, the user has to go to the image forming apparatus site each time and get the result there.

### BRIEF SUMMARY OF THE INVENTION

It is accordingly the object of the present invention to provide an image processing apparatus which can be applied to a color copier, etc., and perform color adjustment and color conversion at high speeds but with high accuracy and at low cost.

The present invention provides an image forming apparatus having an image forming means (6) for, upon receipt of a sort printing instruction, forming an image on a plurality of recording media based on given image information; detecting means (29) for detecting an empty state of each of a plurality of bins in a sorter (24) for sorting the plurality of recording media in accordance with the sort printing instruction, judging means (12) for judging whether or not to feed the plurality of recording media as an additional print output into the bins based on a result of detection by the detecting means (12, 21) for the empty state of the bins; and outputting means for, when the judging means judges that the additional print output be done, allowing the plurality of recording media which are subjected by the forming means to image formation to be fed as an additional print output into the corresponding bins having already other outputted recording media.

The present apparatus is so structured that, when a sort printing instruction is received, even if there are already sort-printed recording sheets on bins in the sorter, copied sheets are fed as an additional print output into the sorter bins under the condition, for example, that an earlier user and current user instructing sort printing this time are the same person, and are so done without involving a confusion even if the copied sheets are fed as an additional print output into the bins. In the case where sort printing instructions are continuously received from the same user on a remote-site PC (Personal Computer) through a cable of a LAN (Local Area Network), etc., in particular, it is not necessary to go from a remote room to a printer room to pick up the copied sheets as a result of printing. This ensures a great benefit to the user.

Further, by rotating the printing-out sheets through an angle of 900 relative to those earlier outputted sheets on the bins it is possible to better separate the currently outputted sheets from the earlier sort-printed sheets.

### BRIEF DESCRIPTION OF THE SEVERAL VIEWS OF THE DRAWING

FIG. 1 is a cross sectional view showing a practical mechanical arrangement of an image forming apparatus according to the present invention;

FIG. 2 is a schematic view showing a practical system of the image forming apparatus according to the present invention;

FIG. 3 is a block diagram schematically showing an electrical equipment of the image forming apparatus according to the present invention;

FIG. 4 is a flow chart showing a sorter-controlling algorithm in the image forming apparatus according to the present invention;

FIG. 5 is a practical sorter management table in the image forming apparatus according to the present invention;

FIG. 6 is a flow chart showing the update processing for updating the sorter management table in the image forming apparatus according to the present invention;

FIG. 7 is a flow chart showing processing for changing the state of the sorter management table from “empty” to “not yet used”;

FIG. 8 is a flow chart for the processing for judging whether or not sort printing can be done in an additional print output mode in the image forming apparatus according to the present invention; and

FIG. 9 is a flow chart showing the processing for judging whether or not it is possible to increase the number of sorter bins required in the image forming apparatus according to the present invention.

### DETAILED DESCRIPTION OF THE INVENTION

An image processing apparatus according to the embodiment of the present invention will be explained below with reference to the accompanying drawings.

<Structure of the Image Forming Apparatus of the Present Invention>

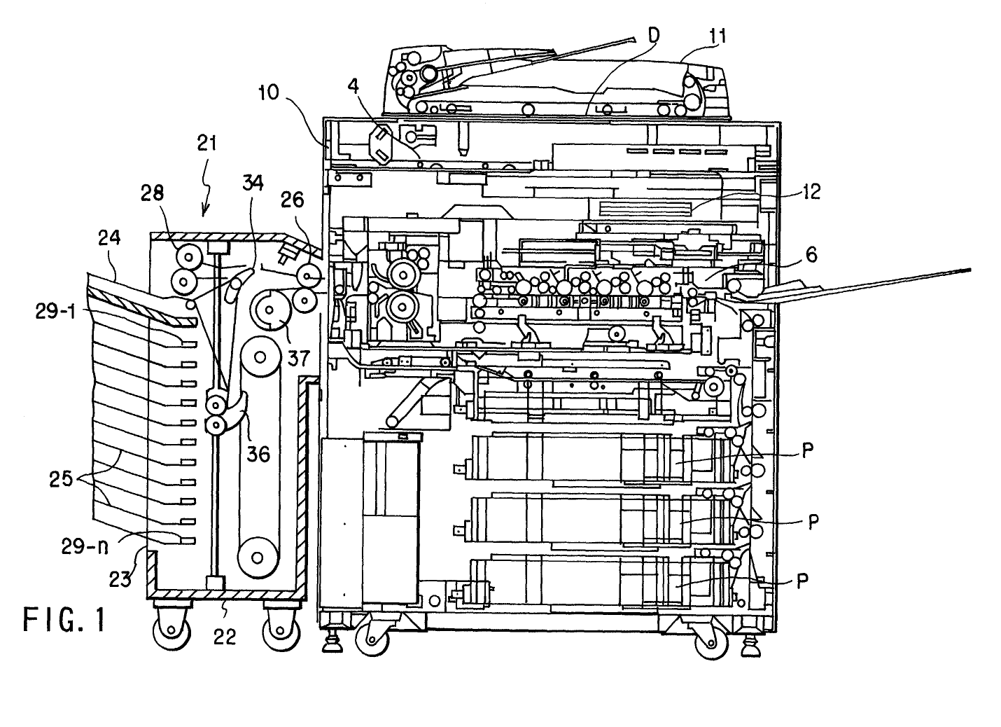

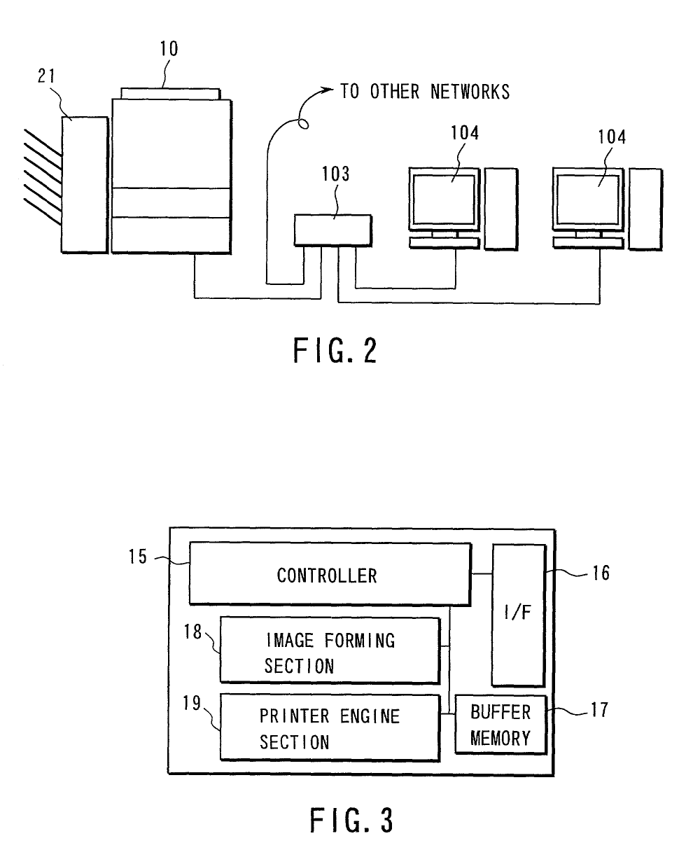

First, the image forming apparatus according to the present invention will be taken by way of example and this structure will be explained below using the accompanying drawings. FIG. 1 is a cross-sectional view showing a mechanical arrangement of one practical form of the image forming apparatus according to the present invention, FIG. 2 is a schematic diagram of a system and FIG. 3 is a block diagram schematically showing an associated electrical equipment.

The image forming apparatus according to the present invention has an apparatus body 10 as shown in FIG. 1. The apparatus body 10 mainly includes an ADF (Auto Document Feeder) 11, image reading section 4 and image forming section 6 and an electrical equipment section 12. Further, a sorter 21 is provided for sort printing.

The sorter 21 is connected to a discharge outlet and has a housing 22 arranged in a side-by-side relation to the apparatus body 10. An opening 23 is provided in the housing 22 on a side opposite to the apparatus body 10. In the housing 21, many trays are mounted in a stacked state along a vertical direction to allow copied sheets which are discharged from the apparatus body 10 to be stacked thereon. These trays include an uppermost non-sorting tray 24 and many sorting bins 25 stacked relative to the non-sorting tray with a given gap defined there. And the non-sorting tray 24 and sorting trays 25 outwardly extend from the opening 23 toward the outside of the housing 22 and sensors 29-1 to 29-n are provided on the extreme ends of the respective bins 25 to judge whether or not there is the copied sheet.

Within the housing 22 there are an inlet roller pair 26 located adjacent to the discharge outlet, outlet roller pair 28 for allowing a copied sheet P which is fed past a discharge path to be discharged by the inlet roller 26 onto the non-sorting tray 24 and flapper 34 located between the inlet roller pair and the outlet roller pair and serving as a sorting means, the inlet roller being located relative to the flapper and having a sheet sensor for detecting an arriving copied sheet P.

The flapper 34 is so provided as to be swingable between a discharge position allowing the copied sheet P which is fed from the inlet roller 26 to be guided to the outlet roller 28 and a sorting position allowing the copied sheet which is fed from the inlet roller 26 to be guided toward the sorting bin 25 side and is switched by a solenoid 25 between both the positions.

Within the housing 22, the sorter 21 has a sorting head 36 so provided as to be movable near the base end of the sorting tray along the stacking direction of the sorting bin 25, that is, the vertical direction, guide roller 37 provided between the inlet roller 26 and the flapper 34 and a belt conveyor 38 arranged below the guide roller 37 along the vertical direction.

The image forming apparatus 10 has, as shown in FIG. 2, a sorter 21-equipped apparatus body 10 connected via a network to a hub, etc., 103 and is supplied with image information and sort printing instruction information from a PC (Personal Computer) 104, etc., connected to the hub, etc., 103. In such a case it is considered that the image forming apparatus 10 is located very remote from the PC 104 operated by the user and, even if the user instructs a few kinds of sort printing, it is desirable that the instruction be continuously issued from the PC side.

FIG. 3 schematically shows one practical form of a transmission system of the image forming apparatus 10 and a block diagram of the electrical equipment 12 and its vicinity. This system has the electrical equipment 18 of the image forming section connected via a bus to a controller 15 and electrical equipment 19 of a printer engine section and further a buffer memory 17 attached to the electrical equipment 12 and further an interface section 16 connected to an outer network.

<Operation of the Image Forming Apparatus According to the Present Invention>

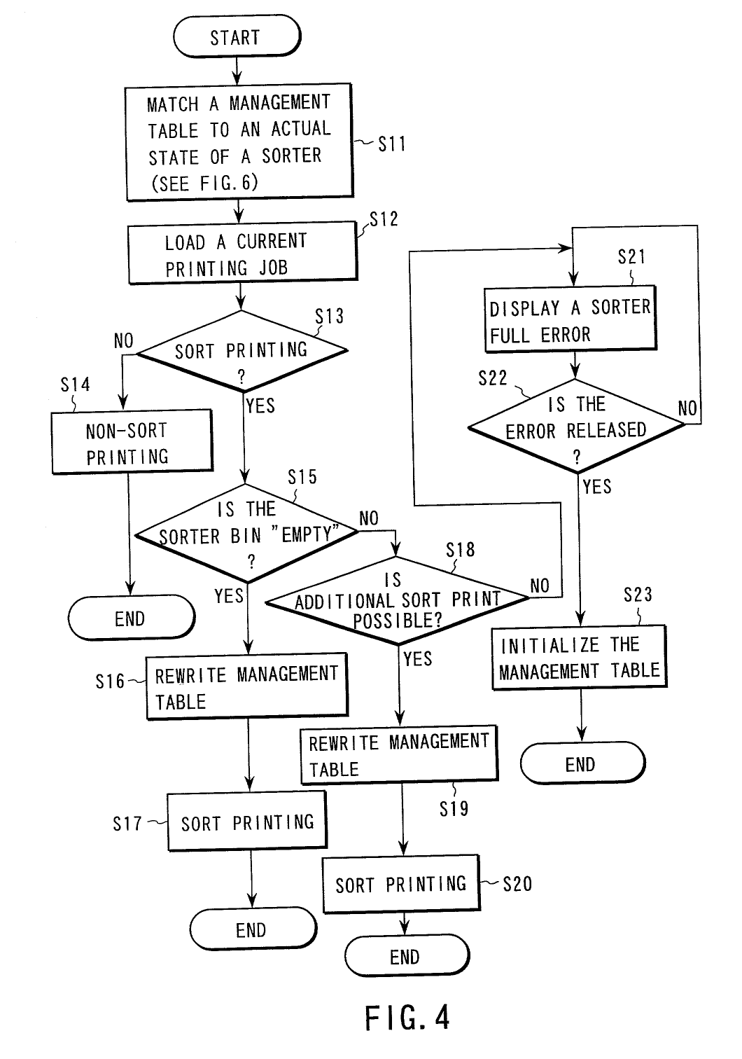

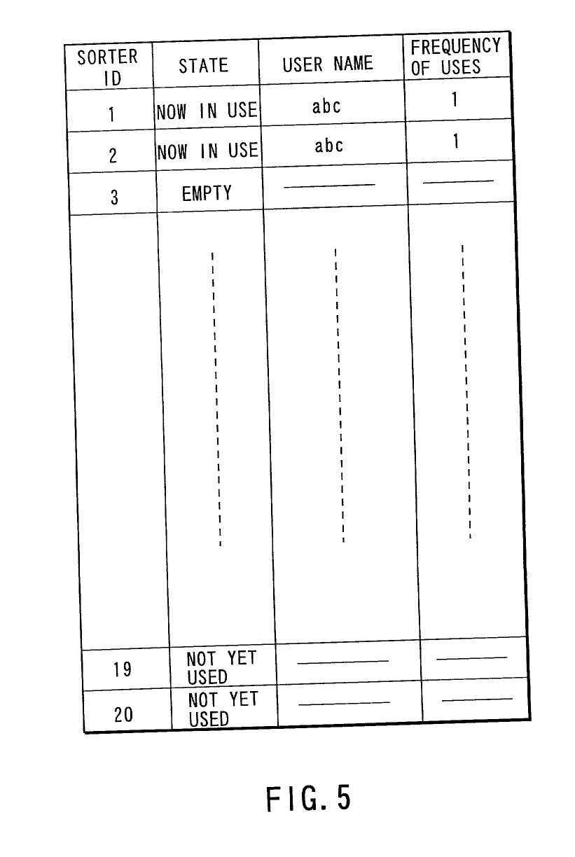

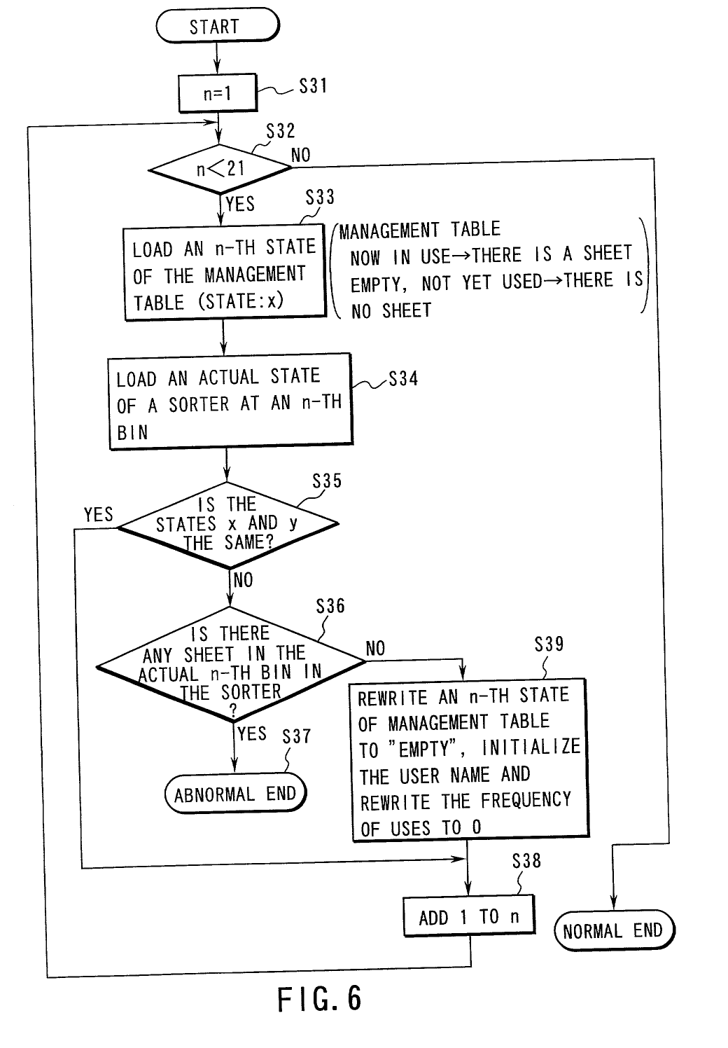

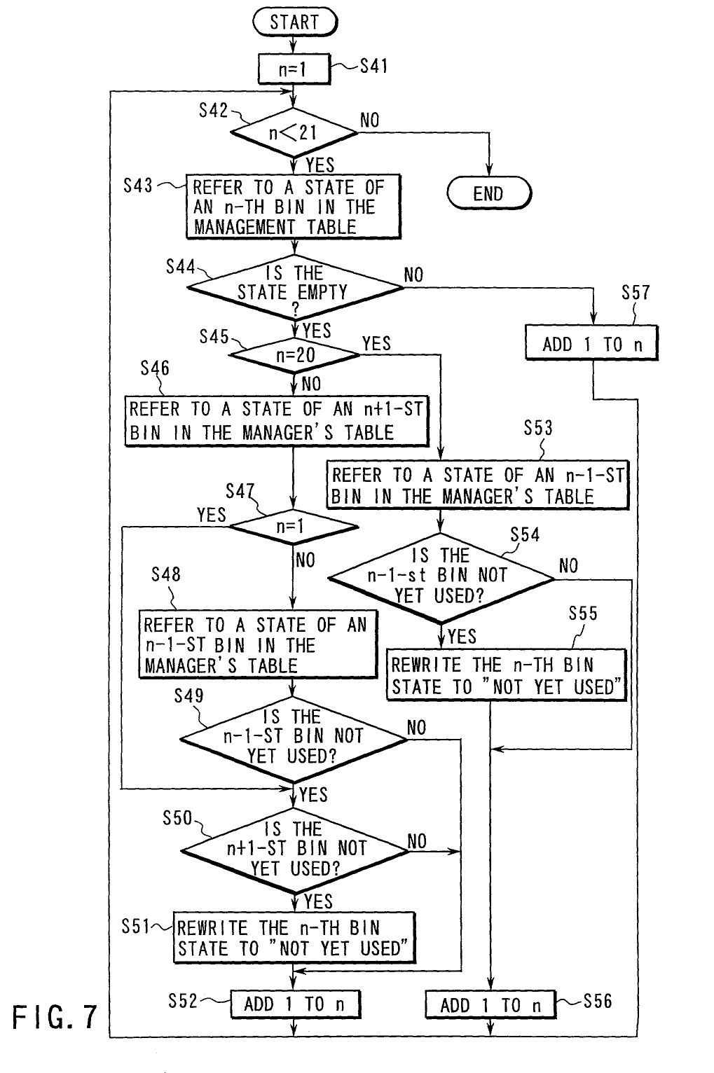

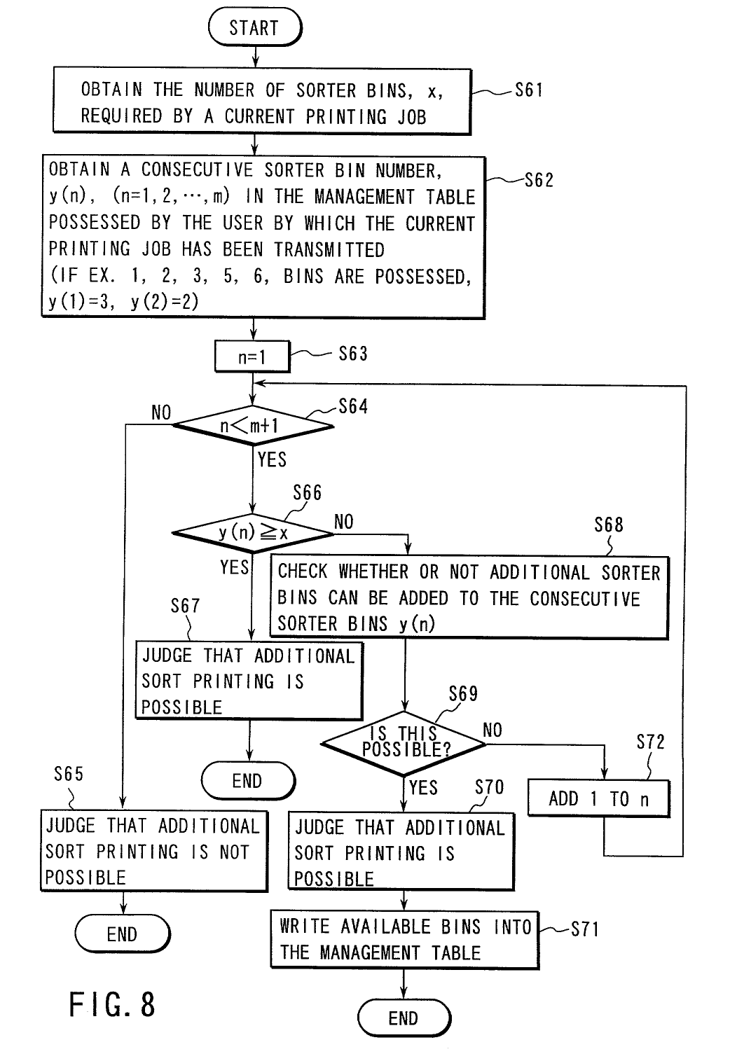

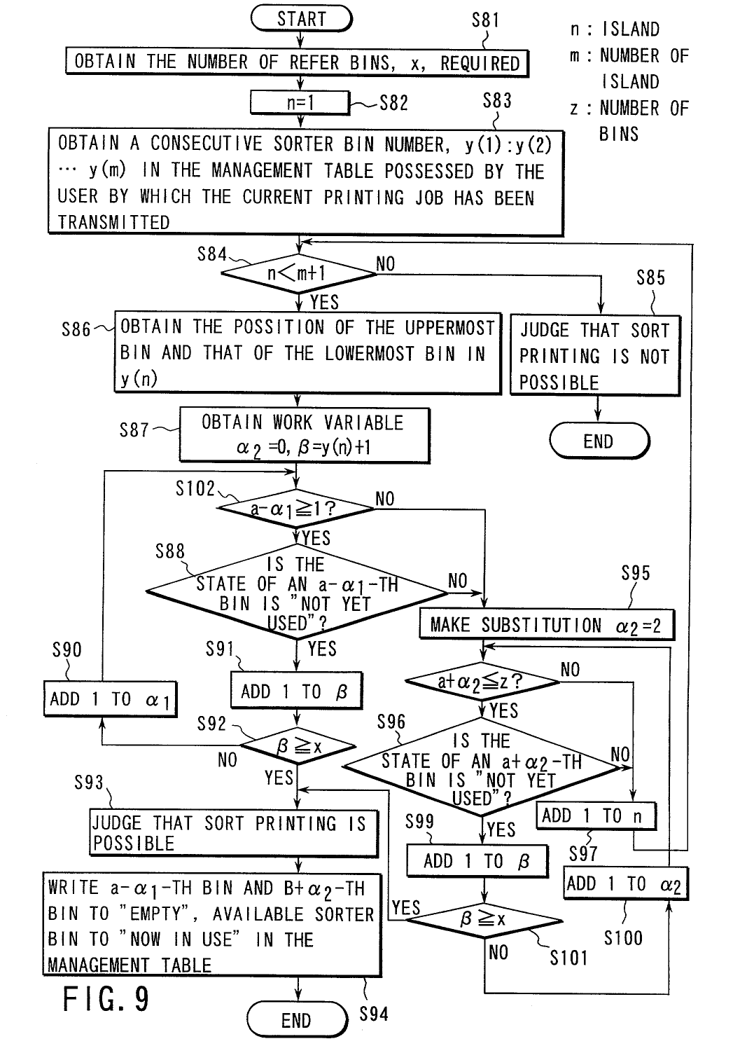

The one practical form of the image forming apparatus according to the present invention has the above-mentioned structure and, now, in connection with the image forming apparatus, a detailed explanation will be made about the operation of performing sort printing according to the present invention while referring to a flow chart, etc. FIG. 4 is a flow chart showing a sorter control algorithm in the image forming apparatus according to the present invention, FIG. 5 is a view showing an example of a sorter management table, FIG. 6 is a flow chart showing the updating processing on the sorter management table, FIG. 7 is a flow chart showing the processing for allowing the state of the sorter management table to be changed from an “empty” state to a “not yet used” state, FIG. 8 is a flow chart showing the processing of judging whether or not sort printing is possible in an additional print output mode and FIG. 9 is a flow chart showing the processing of judging whether or not the number of sorter bins required can be increased.

The image forming apparatus according to the present invention has the above-mentioned structure and a document D picked up by the ADF 11 has its image information scanned by the scanner-equipped image reading section 4 by the use of its CCD. The image information is stored in the electrical equipment 12 and, after being subjected to the predetermined image processing, an image is formed by the image forming section 6 on a copying sheet of an image recording medium on the basis of this image information and an image is so formed by the use of a drum, etc., and is fixed by a fixing device, etc. After this, an image-processed sheet is output as a copied sheet into the non-sorting tray 24 set to the uppermost position.

Now, using the flow chart, an explanation will be made about the formation of an image at the sort printing according to the feature of the present invention. FIG. 4 explanatorily shows the operation algorithm of the sort printing performed by the electrical equipment section 12. First, processing is made by which the management table is matched to the actual state of the sorter (S11). The management table is prepared, in accordance with a later-described flow chart of FIG. 6, with the management information on the states, user names and frequency of uses in the respective sorter bins as shown in FIG. 5. Here, the state “now in use” means that the bin is now in use by the sort printing, the state “empty” means an empty bin state used to avoid any confusion between a group of bins currently used by one user and a group of bins currently used by the next user and never means the state “not used”, and the state “not used” literally means a “not yet used” bin state. The “user name” means the name of the user under which the sort printing is performed, and the “frequency of uses” means that, if the bin allows a copied sheet to be fed therein as an additional print output, then the frequency of uses is twice, three times instead of once. Then, a currently requested printing job is loaded (S12) and it is judged whether or not this is sort printing. If NO, this step is judged as being non-sort printing and exits out of the flow chart (S14).

If YES, it is judged whether or not there is any empty sorter bin (S15). If YES, the management table of using bins has it state rewritten from a “not yet used” state to a “now in use” state and its user name written as the name under which the sort printing is designated (S16). And desired sort printing is performed (S17).

In the case where, at an earlier step S15, there is no empty sorter bin, it is judged whether or not a copied sheet can be fed as an additional print output into the sorter bin (S18) which is the feature of the present invention. The detail of this judgment involves a considerably complex process as specified in the flow chart of FIG. 8 and in its subroutine in the flow chart of FIG. 9.

That is, the case where copied sheets can be fed as an additional print output into the sorter bins means the case where those bins already used by the same user or their next consecutive empty bins exist in number corresponding to the number of bins desired to be used. If, therefore, sort printing involving eight consecutive bins is currently requested by a person A and if there are simply no eight consecutive empty bins, then it is judged whether or not there is any island of those consecutive bins already used by the person A. If there are, for example, consecutive 10 bins used by the person A, then copied sheets will be fed as an additional print output into these used bins. Further, the flow chart of FIG. 6 is such that, even if there exist any consecutive six bins as bins used by the person A, it is judged whether or not there exit two or more not yet used bin above or below those used bins. If there exit such not yet used bins, it is possible to get usable eight bins equal to a sum of the used six bins plus the not yet used two bins. And copied sheets can be fed as an additional print output into these bins.

If, at step S18, it is judged that such an additional print output is possible, the “frequency of uses” on the management table in FIG. 5 is incremented from “once” to “twice” (S19) and the sort printing is carried out (S20). By doing to, the copied sheets are fed as an additional print output into the corresponding bins and, since the copied sheets are ones instructed by the same person, there occurs no confusion with those earlier copied sheets and it is thus possible to issue a consecutive sort printing instruction.

If, at step S18, any additional sort printing is not possible, a sorter full error is displayed (S21) and, after the error is released (S22), the management table is processed, thus ending the processing (S23) without performing the sort printing. Thus, a warning is issued to the user to remove sheets from the corresponding sorter bins or the involved sheets are discharged onto the non-sorting bin.

In the case where, of course, all the sorter bins are not yet used and in the case where, with some sorter bins not yet used, the number of the not yet used sorter bins are more than the number of sorter bins required, sort printing is performed and in the case where, even if the number of not yet used sorter bins is short, the number of bins already used by the same user is more than a required number of bins, sort printing is performed to allow copied sheets to be fed as an additional print output into the sorter bins. In the case where a total of the number of the bins already used by the same user plus the number of next consecutive not yet used bins is more than the number of required bins, sort printing is performed in an additional print output mode.

Then, the update processing of the management table will be explained in more detail below with reference to the flow chart shown in FIG. 6 above. The update processing of the management table is a subroutine corresponding to step S11 in the flow chart of FIG. 4. Let it be considered that the management table is set for a sorter having 20 bins. If a current bin number is given by n, processing starts at n=1 (S31). After it is confirmed that n<21 and processing is not performed on all the bins (S32), the n-th state of the management table is read from the buffer memory area 17 in the electrical equipment 12 and is given by x. If there is a sheet, a corresponding bin is now in use and, if there is no sheet, a corresponding bin is not yet used and so registered. Then the actual state of an n-th bin in the sorter is read out from the sensor 29-1 and given by y (S34).

It is judged whether or not the states x and y are the same (S35) and, if these states are the same, 1 is added to n and control goes to the next bin update processing (S38). If these states are different, it is judged whether or not there is any sheet on the actual n-th bin in the sorter. If YES, an abend results (S37). If NO, the n-th state of the management table is handled as “empty” and the user name is initialized and the frequency of uses is made “0” (S39). Thereafter, 1 is added to n and control goes to the next bin update processing (S38). By doing so, the current use state of the sorter bin is reflected on the value in the management table in FIG. 5.

Further, also the flow chart of FIG. 7 shows the update processing for reflecting the used state of the sorter bin onto the management table and, after output sheets are removed, updating processing is made for updating the state from “empty” to “not yet used”. Let it be considered that the management table is set for a sorter having 20 bins and that a current bin number is given by n. Then processing starts at n=1 (S41). After it is confirmed that n<21 and the processing is not applied to all the bins (S42), the n-th state of the management table is read out from the buffer memory area 17 of the electrical equipment 12 (S43). Unless the state is not “empty”, 1 is added to n and control goes to the next bin (S57). If the state is “empty” (S44), after it is confirmed that n is not equal to 20, reference is made to the n+1-st bin state in the management table (S46). If n is not equal to 1 (S47), reference is made to an n−1-st bin state in the management table (S48). If the n−1-st bin is not yet used, confirmation is made whether or not the n+1-st bin is yet used. If it is found that it is not yet used, it is found that this is after already outputted copied sheets have been removed. Since, therefore, it is not necessary to provide any “empty” space for distinguishing between the groups of copied sheets, a change is made from “empty” to “not yet used” (S51). Further, 1 is added to n and control goes to the next bin processing.

Reference is made to an n−1-st bin state in the management table (S53). It is judged whether or not the n−1-st bin is “not yet used” (S54). If YES, the n-th bin is written as “not yet used” (S55) and 1 is added to n and control goes to the next step.

At the subroutine of FIG. 8 a detailed explanation will be made about the processing for judging whether or not additional sort printing is possible at step S18 in the flow chart of FIG. 4. In FIG. 8, the case where additional sort printing is possible corresponds to the case where there exist consecutive bins greater in number than the number of bins required for print outputting, and into which print outputs have already been fed by the same user and the case where a total of the number of consecutive bins into which print outputs have already been fed by the same user plus the number of not yet used consecutive bins is greater than the number of bins required.

In the flow chart (FIG. 8) for confirming this, the number of sorter bins required by a current printing job is confirmed and given by x (S61). Then a consecutive sorter bin number, y(n), (n=1, 2, . . . , m) in the management table possessed by the user by which the current printing job has been transmitted is obtained (S62). Here, n denotes the number of a current island (consecutively used bin group) and m denotes the number of islands. In this case, it is judged whether or not additional sort printing is possible for each island. First, n is set to be equal to 1 (S63) and, after it is confirmed that n is not applied to all the islands (S64), it is judged whether or not the number of bins in the current island (consecutively used bin group) exceeds the number of bins required. If there exist an adequate number of bins, it is judged that additional sort printing is possible (S67).

Here, if it is judged that no adequate number of bins are obtained in this island (consecutively used bin group), it is judged whether or not any bins continuous to this island are yet used (S68). If it is judged that these consecutive bins allow an additional print output (S69), it is judged that additional sort printing is possible (S70). Regarding the used bins, the rewriting of the management table is carried out, such as the writing of the frequency of uses from “once” to “twice” and the state from “not yet used” to (now in use)-S71. Further, if, at step S69, and addition is not possible, then this island (consecutively used bin group) is so handled that an additional print-out is not possible and control goes to the judgment of the next island (S72).

Here, the subroutine of step S68 handling the case where those bins continuous to the island (consecutively used bin group)-where the number of bins is short-are not yet used and it is judged whether or not the number of bins required can be obtained if both are added together will be explained below with reference to the flow chart of FIG. 9. If the number of sorter bins required is given by x (S81) and n is set to be equal to 1 (S82), the user by which the current printing job has been transmitted obtains the number of consecutive sorter bins y(1), y(2), . . . , Y(m) possessed in the management table (S83).

If judgment has been made on all bins (S84), then it is judged that it is not possible to perform sort printing (S85). After it is confirmed that it is otherwise, at y(n), the uppermost bin a position and lowermost bin b position are obtained (S86) and work variables α₁=2, α₂=0 and β=y(n)+1 (S87). It is judged whether or not the state of an a−α₁-th bin is “not yet used” (S88). If YES, 1 is added to β (S91). Unless β≧x, 1 is added to α₁ (S90) and control goes back to step S88. If β is greater than the number of bins, x, (S92), it is judged that sort printing is possible (S93) and those using sorter bins are handled as “now in use” and a−α₁-th and β+α₂-th bins are handled as “empty” and these states are written as “now in use” in the management table (S94).

At step S88, if the state of a−α₁-th bin is “not yet used”, substitution α₂=2 is made (S95). If the state of a+α₂-th bin is “not yet used” (S96), then 1 is added to β (S99). If β is above x (the number of bins) (S101), it is judged that sort printing is possible (S93) and the using sorter bins are handled as “now in use” and a−α₁-th and b+α₂-th bins are handled as “empty” and these states are so written into the management table (S94). It is to be noted that, unless, at step S101, β≧α, 1 is added to α₂ (S100) and control goes back to step (S96). Further, unless, at step S96, the bin is “not yet used”, control goes to judgment on the next bin (S97).

Even if, in this way, the island (consecutively used bin group) to which print outputs has already been made by the same user fails to reach the number of bins used, when those bins continuous to this island are not yet used, additional sort-printing output is possible.

In the case where additional sort printing is to be performed, if the sheet size designated by the printing job is prepared in terms of its length and width dimensions, copied sheets are discharged in a direction different from that of those already printed-out sheets. By doing so it is possible to distinguish the already printed-out sheets from the later-fed copied sheets.

To this end, reference is made to the management table to see the state of those involved bins before discharging copied sheets into the sorter bins. So long as the copying sheet size is, for example, A4, LT, B5 and the copying sheets are set in both the length and wide directions in sheet feeding trays, those copied sheets are discharged into the bins in the width direction when the frequency of printing uses in the management table is even-numbered and in the length direction when odd-numbered. By doing so it is possible to easily distinguish the earlier copied sheets from the later-fed copied sheet. In the case where, however, the printing sheet size is other than the above-mentioned sheet size and the sheet meets the above-mentioned size requirement but it is not possible to determine the width and length directions, it is desirable to judge whether or not their rotation print output should be fed depending upon the situations involved, such as performing straight sort printing without changing their direction.

As already explained in more detail above with reference to the drawings, the present invention provides an image forming apparatus in which, even in the case where the sorter bins are already used ones, if these are those bins into which, under a specified condition, copied sheets are sort-printed by the same user for example, these copied sheets are sort-fed as an additional print output on the bins in a range not involving any confusion on the side of the user. That is, the present invention provides an image forming apparatus in which, after confirming the identity of the user as well as the number of bins required and their consecutively used bin number, etc., additional sort printing, if possible, can be done (this condition is variously considered), by, for example, repeatedly sending sort printing instructions even from a remote-site personal computer over a network, etc., in which case it is not necessary to go to the apparatus site to pick up the copied sheets each time.

What is claimed is:

1. An image forming apparatus comprising:
image forming means (6) for, upon receipt of a sort printing instruction, forming an image on a plurality of recording media based on given image information;
detecting means (29) for detecting an empty state of each of a plurality of bins in a sorter for sorting a plurality of recording media in accordance with a sort printing instruction;
judging means (12) for judging whether or not to feed the plurality of recording media as an additional print output into the bins based on a result of detection by the detecting means for an empty state of the bins; and
outputting means (12, 21) for allowing the plurality of recording media which are subjected by the image forming apparatus to image formation to be fed as an additional print output into those bins when the judging means judges that the additional print output be done, said those bins having already printed-out other recording media.

2. An image forming apparatus according to claim 1, wherein the detecting means includes means for detecting an empty state of each bin in the sorter (24) and preparing a corresponding management table (FIG. 5).

3. An image forming apparatus according to claim 1, wherein the detecting means includes means (12, 29) for detecting an empty state of each bin in the sorter and preparing a management table (FIG. 5) for setting a flag of any one of a “now is use”, “not yet used” and “empty” state of each bin.

4. An image forming apparatus according to claim 1, wherein the detecting means includes updating means (12, 29) which, after detecting an empty state of each bin in the sorter and preparing a management table (FIG. 5) for setting a flag of any one of a “now in use”, “not yet used” and “empty” state, detects the empty state of the respective bin in each given time period and updates the “now in use” and “empty” state to the “not yet used” state.

5. An image forming apparatus according to claim 1, wherein the judging means includes means (12) for judging that, when there are any empty bins based on a result of detection by the detecting means for the empty state of the bins, recording media be fed as a print output onto the empty bins and judging whether or not the recording media be fed as an additional print output onto bins when there are no empty bins.

6. An image forming apparatus according to claim 1, wherein the judging means includes means (12) for checking a result of detection by the detecting means for the empty state of the bins and, when sheets are present on the bins, judging that copied sheets be fed as an additional print output into the bins if the user is the same person by which sort printing is designated this time.

7. An image forming apparatus according to claim 1, wherein the output means includes means (12, 21) for judging whether or not the recording media can be outputted with their direction rotated through a predetermined angle when it is judged that the recording media be fed as an additional print output into bins and, if this can be done, allowing the recording media which is subjected by the image forming means to image formation to be rotated through a predetermined angle and the recording media to be fed as an additional print output into those bins having already outputted other recording media.

8. An image forming apparatus according to claim 1, wherein the output means includes means (12, 21) which, when the judging means judges that the recording media be fed as an additional print output into bins, if the recording media have a A4, an LT or a B5 size, allows the recording media which is subjected by the forming means to image formation to be rotated through a predetermined angle and these recording media to be fed as an additional print output into those bins in the sorter which have already outputted other recording media.

9. An image forming apparatus according to claim 1, wherein the forming means includes means (6, 12), having a network-linked communication function (12), for receiving a sort printing instruction and image information from an apparatus (104) connected thereto via the network and forming an image on the recording media based on the image information.

10. An image forming apparatus comprising:
a forming mechanism for forming an image on a plurality of recording media based on given image information when a sort printing instruction is received;
a sensor (29) for detecting an empty state of each of a plurality of bins in a sorter (24) for sorting the recording media in accordance with the sort printing instruction;
a control circuit (12) for judging whether or not to feed the plurality of recording media as an additional print output into bins based on a result of detection by the sensor for the empty state of the bins; and
an output mechanism (12, 21) for allowing the plurality of recording media which are subjected by the image forming mechanism to image formation to be fed as an additional print output into those bins when the control circuit judges that such additional print output be performed, said those bins having already outputted other recording media.

11. An image forming apparatus comprising:
a forming mechanism (6) for forming an image on a plurality of recording media based on given image information when a sort printing instruction is received;
a control circuit (12, 29) for detecting, by a sensor (29), an empty state of each of a plurality of bins in a sorter for sorting the recording media in accordance with a sort printing instruction and preparing a management table (FIG. 5) for setting a flag of any one of a “now in use”, a “not yet used” and “empty” state of each bin;
a control circuit (12) which, based on the management table prepared by the control circuit, judges that, when there are empty bins, the recording media be print-outputted into the empty bins, judges that, when there are any sheets in the bin, an additional print output be fed into the bin if the user is the same person by which sort printing is designated this time, and judges whether or not the recording media can be print-outputted in a manner to have their direction rotated through a predetermined angle; and
an output mechanism (21) which, when the control circuit judged that the recording media can be print-outputted in a manner to have their direction rotated through a predetermined angle, allows the recording media which are subjected by the forming means to image formation to be rotated through the predetermined angle and be fed as an additional print output into the corresponding sorter bins having already outputted other recording media.

12. An image forming method comprising the steps of:
upon receipt of a sort printing instruction, forming an image on a plurality of recording media based on given image information (6);
detecting an empty state of each of a plurality of bins in a sorter (24) for sorting the plurality of recording media (29) in accordance with a sort printing instruction;
judging means for judging whether or not to feed the recording media as an additional print output into bins based on a result of detection by the detecting step for an empty state of the bins (12); and
when the judging step judges that the additional print output be fed into the bins, allowing the plurality of recording media which are subjected by the forming step to image formation to be outputted, as an additional print output, into those bins in the sorter where already outputted other recording media are present (12, 21).

13. An image forming method according to claim 11, wherein the detecting step includes the step of detecting an empty state of each of a plurality of bins in a sorter (24) and preparing a corresponding management table (FIG. 5).

14. An image forming method according to claim 11, wherein the detecting step includes the step of detecting an empty state of each of the plurality of bins in the sorter (24) and preparing a management table (FIG. 5) for setting a flag of any one of a “now in use”, a “not yet used” and “empty” state of each bin (12, 29).

15. An image forming method according to claim 11, wherein the detecting means includes the step of, after detecting the empty state of each of the plurality of bins in the sorter (24) and preparing the management table (FIG. 5) for setting a flag of any one of a “now in use”, a “not yet used” and an “empty” state of each bin, updating the “now in use” and “empty” sate to the “not yet used” state (12, 29).

16. An image forming method according to claim 11, wherein the judging means includes the step of, when there are empty bins based on a result of detection by the detecting step for the empty state of the bins, judging that the recording media be print-outputted into the empty bins and, when there are no empty bins, judging whether or not the recording media be fed as an additional print output into the bins.

17. An image forming method according to claim 11, wherein the judging step includes the step of, when the result of detection by the detecting step for the empty state of the bins is checked and it is found that there are sheets on the bins, if the user is the same person by which a sort printing instruction is issued this time, judging that copied sheets be fed as an additional print output into the bins (12).

18. An image forming method according to claim 11, wherein the outputting step includes the step of, when the judging step judges that the recording media be fed as an additional print output onto bins, judging whether or not the recording media can be outputted in a manner to have their direction rotated through a predetermined angle and, if can, rotating the recording media which are subjected by the forming step to image formation through a predetermined angle and feeding the recording media as an additional print output into the corresponding bins in the sorter (12, 21).

19. An image forming method according to claim 11, wherein the outputting step includes the step of, when the judging step judges that an additional print output be fed into the bins, if the recording media have an A4, and LT or a B5 size, rotating the recording media which are subjected by the forming step to image formation through a predetermined angle and allowing the recording media to be outputted as an additional print output into the corresponding bins in the sorter (12, 21).

20. An image forming method according to claim 11, wherein the forming step includes the step of receiving a sort printing instruction and image information from an apparatus having a network-linked communication function (12) and connected via the network and forming an image on a plurality of recording media based on the image information (6, 12).
